(19) United States
(12) Patent Application Publication
(10) Pub. No.: US 2015/0352386 A1
(43) Pub. Date: Dec. 10, 2015

(54) SPRINKLER SHUT-OFF APPARATUS

(71) Applicant: HEADSEAL LTD., Cheshire (GB)

(72) Inventor: Mark SHELBOURNE, Cheshire (GB)

(21) Appl. No.: 14/761,855

(22) PCT Filed: Jan. 14, 2014
(86) PCT No.: PCT/GB2014/050092

§ 371 Date: Jul. 17, 2015

(30) Foreign Application Priority Data
Jan. 18, 2013 (GB) 1300968.3

(51) Int. Cl. A62C 37/20; A62C 35/68

(52) U.S. Cl. CPC A62C 37/20; A62C 35/68

(57) ABSTRACT

A sprinkler shut-off apparatus is provided. The apparatus includes a first connector sealingly affixable, in use, to a water outlet orifice of a first fire sprinkler head and means for releasably retaining the first connector to the said water outlet orifice. The apparatus further includes a conduit extending between, and in fluid communication with, the first connector and a second connector, the second connector being adapted to provide a connection, in use, to a second fire sprinkler head affixed thereto.

This invention relates to sprinkler shut off devices.

Fire sprinkler systems are nowadays fitted in most new buildings. A typical sprinkler system comprises one or more sprinkler heads that are operatively connected to a mains and/or pressurised water supply via pipes. The sprinkler head or heads comprise a normally-closed valve that opens automatically in the event of a fire to allow water to spray through the sprinkler head to douse the flames or fire. The sprinkler head usually comprises an outlet aperture through which the water flows, in use, and a deflector plate arranged to deflect the jet of water into a desired spray pattern. The desired spray pattern is often circular, and the sprinkler head can be positioned so as to create different spray patterns for different situations. For example, a car park (parking lot) is often provided with sprinkler heads arranged to create an umbrella-shaped spray pattern, to shower, for example, a burning car located below it. On the other hand, in an office situation, the sprinkler head can be angled to spray upwards towards the ceiling so as to wet the ceiling so that the water eventually runs down the walls, containing the fire within a particular room.

The normally-closed shut-off valve of many types of sprinkler head comprises a bung that is used to sealingly close the water outlet orifice of the sprinkler head, which leads to the water supply pipe. The bung is held in place by a retainer interposed between the bung and the deflector plate and the retainer usually comprises a frangible, e.g. a glass, vial containing a quantity of inert liquid. The inert liquid has a relatively high coefficient of thermal expansion such that when the vial is heated, the liquid expands and fractures the vial, thus releasing the retainer and bung to allow water to escape through the outlet orifice of the sprinkler head. The construction and operation of sprinkler heads is well known and does not require further detailed explanation here.

When a sprinkler head is set off, it cannot be easily reclosed, which is necessary in an actual fire situation. However, where a sprinkler is set off accidentally, this can be problematic as the escape of water can cause damage to the surrounding area, and may cause flooding. Accidental sprinkler damage is quite commonplace owing to the intentionally fragile nature of the aforementioned vial. For example, inadvertent knocking of the sprinkler's head by a decorator's ladder can cause the vial to be broken thus setting off the sprinkler system.

Once a sprinkler has been set off, accidentally, or following the outbreak of a fire, it can be disabled by re-plugging its outlet orifice. Fire crews commonly close-off sprinkler heads by hammering a pair of opposing wooden wedges between the outlet orifice and the deflector plate, but this leaves the area surrounding the sprinkler unprotected in the event of an actual fire occurring, or a fire re-kindling. Alternatively, the mains water supply can be shut-off, but this can leave the entire building unprotected.

To address the aforementioned problems, various types of temporary sprinkler shut-off devices have been developed, which comprise rubberised jaws that are effectively used in place of the aforementioned wooden wedges to re-seal the sprinkler head's outlet orifice. The jaws are placed between the sprinkler's outlet orifice and the deflector, and can be spread apart by a hand-operated friction ratchet mechanism, which serves to seat one of the jaws against the periphery of the sprinkler head's outlet orifice, which seals it closed.

The friction ratchet mechanism is adapted to release the jaws when the temperature in the vicinity of the device increases beyond a predetermined temperature thereby releasing the ratchet mechanism and allowing the closure device to be ejected from the sprinkler head under the pressure of the escaping water.

Despite the advantages of the known devices, they nevertheless suffer from a number of drawbacks. Firstly, installing known devices can be difficult because the pressure of the flowing water impedes access to the sprinkler head and can make it difficult for an operator to see what he or she is doing; the device can only be fitted to a sprinkler where the deflector plate is intact; and when the device is released during, say, a fire re-kindling event, although the water can flow, there is no way to be sure that the spray pattern will be as required. Also, most, if not all of the known sprinkler re-closing systems are single use devices. In addition, especially in locations where vehicles operate, there is a risk that the sprinkler head can be damaged, for example, with the deflector plate and/or its mountings being sheared off, in which case, known devices, cannot be used to re-close the sprinkler.

A need therefore arises for a new or improved type of sprinkler shut-off device that addresses one or more of the above problems.

According to the invention, there is provided a sprinkler shut-off apparatus comprising a first connector sealingly affixable, in use, to a water outlet orifice of a first fire sprinkler head and means for releasably retaining the first connector to the said water outlet orifice, wherein the apparatus further comprises a conduit extending between, and in fluid communication with, the first connector and a second connector, the second connector being adapted to provide a connection, in use, to a second fire sprinkler head affixed thereto.

In other words, the invention may provide a temporary bypass between a broken sprinkler head and a replacement, intact, sprinkler head. One possible advantage of the invention is that by providing a second fire sprinkler head, the fire protection of the sprinkler system is maintained indefinitely, that is to say, the fire protection provided with the apparatus fitted to a broken fire sprinkler head can be identical with the fire protection provided by an intact fire sprinkler head without the apparatus fitted. The second fire sprinkler head can be selected from any one of a variety of sprinkler heads, but ideally, the second fire sprinkler head will be identical with, or of the same specification as, the broken fire sprinkler head which the apparatus is replacing.

By providing a second connector, it is possible to interchange the second fire sprinkler head for one matching that of the broken fire sprinkler head, if required. The second connector may comprise a screw-fitting type connector to which the second fire sprinkler head can be affixed. Additionally or alternatively, the second connector may comprise a quick release and/or push-fit type of connector, which may facilitate interchanging of the second fire sprinkler head.

The first connector is sealingly affixable, in use, to the water outlet orifice of the fire sprinkler head. The first connector thus suitably comprises a seal that is adapted to seat around the periphery of the water outlet orifice, which may take the form of a resiliently deformable member having a through aperture therein, or an O-ring seal. Additionally the first connector may comprise a tapered U-shaped guide to help align the tube and O ring seal of the first connection to the water outlet of the orifice of the sprinkler head. This U-shaped guide, is made of a strong thin wire, which whilst helping alignment also allows a clear uninterrupted flow of water through the connection between the water outlet orifice of the sprinkler head to the first connector of the outlet orifice

The means for releasably retaining the first connector to the water outlet orifice suitably comprises a mechanism adapted to engage the first connector with the water outlet orifice. The mechanism may be formed integrally with the sprinkler shut-off apparatus, or it may be detachably connectable thereto. The mechanism suitably comprises a hand-operated ratchet mechanism adapted to compress the first connector against the water outlet orifice. The means for releasably retaining the first connector to the water outlet orifice suitably comprises means for engaging a part of the broken sprinkler head being replaced, preferably a part other than the deflector plate or the deflector plate mounting limbs. Suitably, the means for releasably retaining the first connector to the water outlet orifice is engageable, in use, with a flange portion of the broken sprinkler head being replaced, for example, by a forked connector that engages the said flange portion. The forked connector is preferably elongate to allow it to be offered up to the flange portion with the first connector clear of the water outlet orifice, which configuration advantageously reduces the likelihood of creating a spray of water towards the operator of the apparatus, but which can be slid quickly into position to minimise any such spraying.

The conduit extends between, and is in fluid communication with, the first connector and the second connector. The conduit suitably comprises a bifurcated portion with a first limb thereof leading to the second connector, and a second limb thereof leading to a bypass outlet that directs the water from the water outlet orifice away from the operator. A diverter valve means is preferably provided to allow the selection of water flow to one or both of the second connector and the bypass outlet. The diverter valve means is preferably conveniently located so as to allow it to be hand operated, preferably single-handedly, by an operator.

The apparatus suitably takes the form of a hand-operable tool comprising a pair of moveable grip portions, graspable, in use, by an operator's hand, which can be used to actuate a mechanism for retaining the apparatus in situ. Conveniently, the other controls of the apparatus, for example, a mechanism release, a diverter valve control button or knob, etc. are ergonomically located so as to facilitate single-handed operation of the device.

Various embodiments of the invention shall now be described, by way of example only, with reference to the accompanying drawings in which:

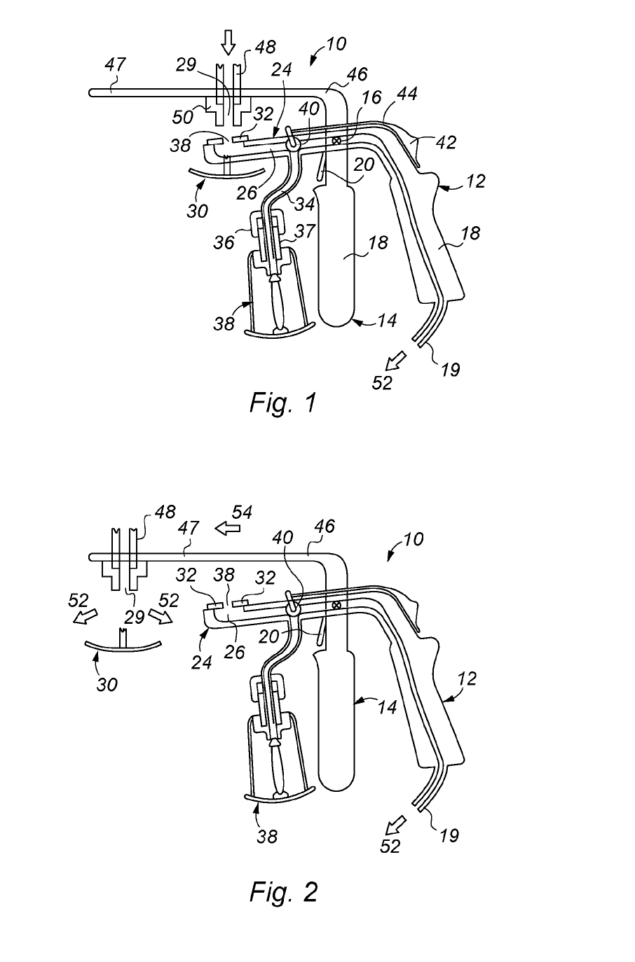

FIGS. 1 to 4 are a sequence of schematic side views showing the operation of a first embodiment of the invention;

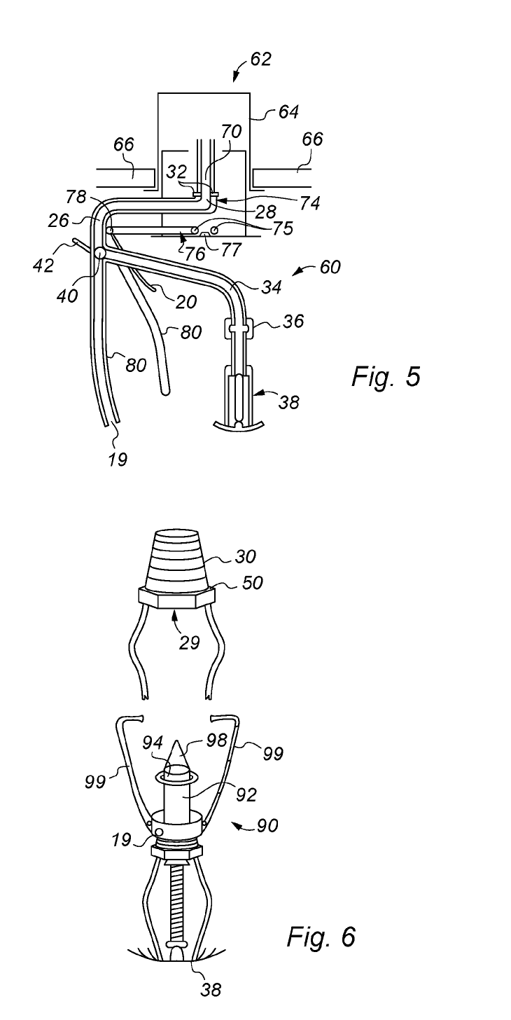

FIG. 5 is a schematic side view of a second embodiment of the invention, suitable for use with recessed sprinkler heads;

FIG. 6 is a schematic side view of a third embodiment of the invention; and

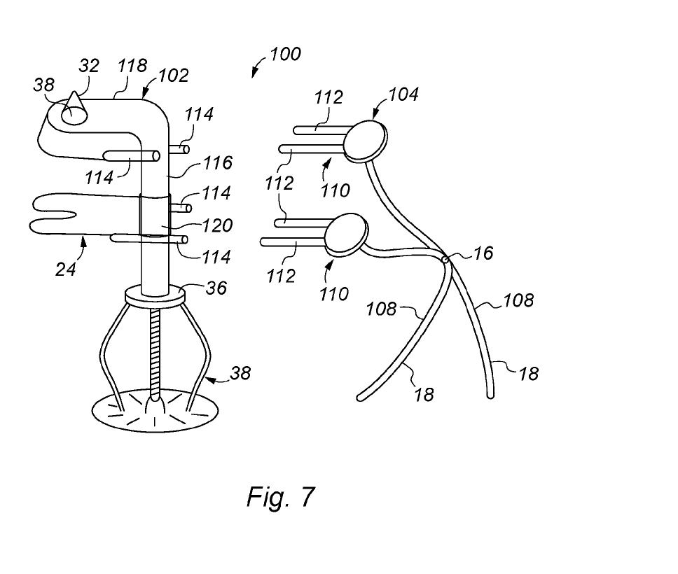

FIG. 7 is a schematic view of a two-part sprinkler shut-off device in accordance with the invention having a detachably connectable installation tool.

In FIGS. 1 to 4, a shut-off device according to the invention comprises a plier-type device 10 that can be grasped by a user's hand. The plier-type device 10 comprises first 12 and second 14 pivotally interconnecting portions that pivot relative to one another about a pivot pin 16. The pivotally interconnecting portions 12, 14 are each provided with ergonomically-shaped grip handles 18 that facilitate stably grasping them, in use, such that a user can easily close the plier-type device 10 using one hand.

Interposed between the first 12 and second pivotally interconnected portions is a ratchet mechanism (not visible), which acts to retain the plier-type device 10 in a closed position. The ratchet mechanism can be released by a user depressing a lever 20 connected to the ratchet pawl (not visible), which lever 20 is located above one of the grip handles 18, adjacent, in use, a user's forefinger, when grasping the handles 18. The plier-type device 10 can thus be readily released, when desired, single-handedly.

A first one of the pivotally interconnected portions 12, namely the one that seats against the user's palm, in use, comprises a first upper jaw portion 24 that extends forward from a point near to the pivot pin 16. The first upper jaw portion 24 comprises a robustly-constructed limb having an internal tube 26 terminating an orifice 28 located near to its tip. The orifice 28 is positioned to bear against the outlet orifice 29 of a broken or activated sprinkler head 30, as shall be described below. Surrounding the orifice 28 is an annular rubber seal 32 that seats against, and forms a seal against, the periphery of the outlet orifice 29 of the broken sprinkler head 30.

The internal tube 26 extends within the first pivotally interconnected portion 12 and extends out from the free end of the handle 18 to form a bypass outlet 19 which directs water away from the user, during use. The internal tube 26 bifurcates and a second portion 34 thereof extends downwardly from the first upper jaw portion 24 and terminates in a push-fit tube connector 36. The push-fit tube connector 36 receives a length of tube 37 to which an intact, replacement sprinkler head 38, of the same type or specification as the broken sprinkler head 30 that it is replacing. The use of a push-fit connector 36 facilitates changing the intact sprinkler head 38 for one of a different type, should the need arise. The connector 36 is suitably of a quick-release type so that no tools are required to change the second sprinkler head 38.

A diverter valve 40 is provided where the internal tube 26 bifurcates to allow a user to select the flow path of water from the broken sprinkler head 30. In one valve position, the water is directed out through the bypass outlet 19, whereas in a second position, the water is directed through the second tube portion 34 towards the intact sprinkler head 38. Actuation of the diverter valve 40 is effected by a slide button 42 that is connected, via a linkage 44, to a control knob of the diverter valve 40. The slide button 42 is conveniently located adjacent the user's thumb, in use, thus allowing the user to actuate the diverter valve 40 single-handedly.

The second one of the pivotally interconnected portions 14 comprises a forked abutment plate 46 that extends forward from, and above the level of, the pivot pin 16. The tines 47 of the forked abutment plate 46 are able to slide on either side of the water inlet pipe 48 of the broken sprinkler head 30 to abut the upper surface of a flange portion 50 thereof. By closing the plier-type device 10, the upper jaw portion and the forked abutment plate 46 move together, and are locked in place by the ratchet mechanism to form a seal between the orifice 28 of the jaw portion and the outlet orifice 29 of the broken or activated sprinkler head 30.

As can be seen in FIG. 2, the forked abutment plate 46 is elongate, allowing the plier-type device 10 to be offered up to the broken sprinkler head 30 without interfering with the water jet 52 emanating from the broken sprinkler head's outlet orifice 29. This facilitates correctly aligning the tines 47 of the forked abutment plate 46 on either side of the sprinkler's inlet pipe 48. Once aligned, the plier-type device 10 can be pushed forward in the direction indicated by arrow 54 until the water pipe 48 abuts an end-stop of the forked abutment plate 46 (as shown in FIG. 1), at which position, the broken sprinkler head's outlet orifice 29 is aligned with the inlet orifice 28 of the upper jaw portion 24. In this position, the diverter valve 40 is set so as to direct the flow of water 52 shown in FIG. 1 to the bypass outlet 19 to minimise the spray of water from the broken sprinkler head 30 towards the operator.

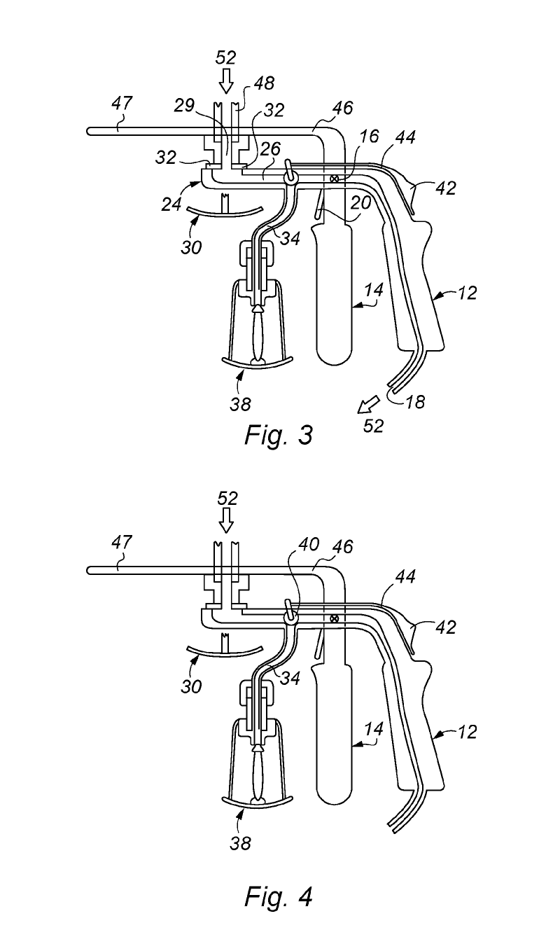

Once aligned, as shown in FIG. 3, the handles 18 are squeezed together to seat the seal 32 of the upper jaw portion 24 against the periphery of the broken sprinkler head's outlet orifice 29. The ratchet mechanism will, of course, retain the handles 12, 14 in the closed position when the user's grip is released. Meanwhile, the diverter valve 40 remains in the position to divert the water 52 to the bypass outlet 19 until such time as the operator is satisfied that a seal has been formed, at which point, the diverter valve 40 position can be changed by depressing the button 42, to divert the flow of water towards the replacement sprinkler head 38. The replacement sprinkler head 38 is intact, and thus stops the flow of water from the broken sprinkler head 30, whilst providing an intact replacement therefor having an identical or similar operation characteristic as the broken sprinkler head, thus restoring the fire protection.

It will be noted that the forked abutment plate 46 engages with the connector flange potion 50 of the broken sprinkler head 30, and is thus able to function (as shown in FIG. 4, for example) even where the deflector plate 56 of the broken sprinkler head 30 has been removed.

The invention can be applied to meet the requirements of other types of sprinkler head systems, for example, sprinkler heads of the recessed type that are becoming more commonly fitted to domestic dwellings. An example a sprinkler shut off device 60, for use with a recessed sprinkler head 62, is shown in FIG. 5. A recessed sprinkler head 62 comprises a cylindrical receptacle 64 that is flush mounted in a ceiling or wall 66. A slideably moveable sprinkler head 68 is received in the receptacle 64 and is held in a raised position by a soldered connection. When in the raised position, the sprinkler head is shut off, but when the ambient temperature increases, the soldered joint is melted, releasing the moveable sprinkler head 68 thus allowing it to drop down, in which position, a bung (not shown) closing the sprinkler head's outlet orifice 70 is ejected by the water pressure in the outlet orifice 70. A generally flat plate 72 of the moveable sprinkler head portion 68 serves to conceal the sprinkler when in a raised position, and also serves as a spray deflector plate when the sprinkler is operational. Due to the recessed nature of a recessed sprinkler head 62, a shut off device 10, as shown in FIGS. 1 to 4 cannot be used. In this case, a plier-type sprinkler shut off device 60 needs to work in an opposite sense, that is to say with its jaws opening to engage the activated or broken sprinkler head's outlet orifice 70.

In FIGS. 5 and 6, it can be seen that the second embodiment of the sprinkler shut off device 60 according to the invention also comprises a plier-type device 60 that is adapted to sealingly engage the periphery of the activated or broken sprinkler head's outlet orifice 70. In this example, however, the upper jaw portion 74 is held in place by the action of a lower jaw portion 76 engaging the upper surface of the deflector plate 72. The upper 74 and lower 76 jaw portions are pivotally connected to one another about a pivot pin 78 such that squeezing their respective handles 80 together causes the upper 74 and lower 76 jaw portions to separate bringing the upper jaw portion 74 to bear against the outlet orifice 70 of the activated or broken sprinkler head 62. The upper 74 and lower 76 jaw portions are pivotally connected by a ratchet mechanism, not shown, to enable their positions to be releasably locked, as previously described.

Also as previously described, in relation to FIGS. 1 to 4, the upper jaw portion 74 comprises an annular seal 32, such as an O-ring seal, that seats against the periphery of the outlet orifice, which provides a sealing connection to an internal tube portion 26 of the upper jaw portion 74 through which water can flow.

Similarly, the internal tube 26 bifurcates into a bypass outlet 19 and a limb portion 34 leading to a replacement sprinkler head 38 that is releasably connected thereto by a push-fit connector 36 as previously described. A diverter valve 40 is also provided to allow the flow of water to be selected to flow to the bypass outlet 19 or to the replacement sprinkler head 38, as desired.

In use, an operator initially moves the diverter valve 40 to a position in which water is directed to the bypass outlet 19 and offers the shut off device 60 up to the activated or broken sprinkler head 62. The lower jaw portion 74 comprises a recess or aperture 75 that can locate on a boss or protrusion 77 of the deflector plate 72. This location aligns the inlet orifice 28 of the upper jaw portion 74 with the outlet orifice 70 of the activated sprinkler head 62. With the diverter valve 40 thus set, water flows into the internal tube 26 and out through the bypass outlet 19, thus reducing the amount of water spray directed towards the user. Once aligned, the handles 80 can be squeezed together to bring the upper jaw portion 74 into abutment with the outlet orifice 70 of the activated sprinkler head 62 whereby the O-ring seal 32 seats against, and forms a seal with the outlet orifice 70. The ratchet mechanism (not shown), maintains the jaws 74, 76 in this position, until released using a ratchet release lever 20 provided on the handle 80 of the device 60. Once the user is satisfied that a seal has been formed, the diverter valve 40 position can be changed to divert the flow of water 52 along the second limb portion 34 towards the replacement sprinkler head 38, thus restoring the sprinkler system to a closed, but operational status, substantially as it was prior to activation or breakage of the recessed sprinkler head 62.

FIG. 6 shows a third possible embodiment of the invention, in which a clip-type device is used to secure a replacement sprinkler head 38 to a broken one 30. In FIG. 6, the shut off device 90 comprises a pair of concentric tubes 92, 94 providing alternative flow paths to a bypass outlet 19 and to a replacement sprinkler head 38: the outer tube 92 being in fluid communication with the bypass outlet 19, and the inner tube 94 being in fluid communication with the replacement sprinkler head 38. The inner 94 and outer 92 tubes are relatively slideable and the inner tube 94 is spring biased towards and extended position by a compression spring (not visible). The tip 98 of the inner tube 94 comprises a tapered centraliser 98 that locates with the outlet orifice 29 of the broken sprinkler head 30. The clip-type shut-off device 90 can be offered up to a broken sprinkler head 30 and water flows through it to the bypass outlet 19, until such time as the inner tube is correctly seated with the outlet orifice 29 of the broken sprinkler head. Pushing the shut off device 90 fully home compresses the compression spring (not visible) allowing the inner 94 and outer 92 tubes to slide relative to one another, by which action, an internal diverter valve 40 is actuated to cause the flow of water to be directed towards the replacement sprinkler head 38 instead of the bypass outlet 19. The clip-type shut off device 90 is retained in situ by two or more spring-loaded arms 99 that extend towards the broken sprinkler head 30, and which engage it behind a flange portion 50 thereof.

In FIG. 7, a further alternative embodiment of the invention 100 comprises a main body portion 102 and an insertion tool 104 for it. The main body portion 102 comprises many of the same features as the embodiments previously described, and identical reference signs have been used to identify identical features for the sake of clarity, and to avoid repetition. The embodiment shown in FIG. 7, however, differs from the previously described embodiments inasmuch as the user-graspable handles 18 are formed in a tool 104 that is separate from the main body portion 102. The tool 104, therefore, essentially comprises a plier-type device having a pair of pivotally interconnected portions 106, 108 that pivot about a pivot pin 16, and which have jaws 110 that terminate in forked tines 112 that are slidingly receivable in suitably located receptor tubes 114 of the main body portion 102. The tool 104 can thus be offered up to the main body portion 102 to actuate it.

The main body portion 102, on the other hand, comprises a hollow, tubular body portion 116 having an upper limb 118 that extends substantially perpendicularly thereto. The upper limb 118 has an inlet orifice 38 surrounded by a rubber centraliser 32 that serves to align the orifice 38 with the outlet orifice of a sprinkler head (not shown), and which is resiliently deformable so as to seat against, and to form a watertight seal with, the periphery of the sprinkler's outlet orifice. The tubular body portion 116 extends downward and terminates in a connector 36 to which a replacement sprinkler head can be affixed.

The tubular body portion is retained in situ with respect to the broken sprinkler head (not shown) by virtue of a lower jaw portion 24 that extends outwardly from a tubular sleeve 120 that surrounds the tubular body portion 116 of the main body 102. In one embodiment, the sleeve 120 is spring-biased away from the upper limb 118 so as to grip it in position, but which can be slid upwardly, against the action of the spring, using the insertion tool. In another embodiment, the sleeve 120 comprises a ratchet assembly (not visible) that enables the sleeve to ratchet away from the upper limb 118 as the handles 18 of the tool 104 are squeezed together.

Once the main body portion 102 has been correctly placed on the broken sprinkler, the insertion tool 104 can be removed. Such a configuration reduces any loading on the broken sprinkler head, and also allows a single tool 104 to be used for a number of sprinkler head replacements, which reduces capital outlay and, potentially, the amount of equipment a fire crew or maintenance engineer needs to carry.

The invention is not restricted to the details of the foregoing embodiments, which are merely exemplary of the invention. In one envisaged variant of the invention, the angles of the devices are adjustable to allow the invention to be used in conjunction with wall, ceiling or angled sprinkler heads. The materials of construction, and the specific shape and configuration of the embodiments described are just examples of a number of ways that the invention could be implemented.

1. A sprinkler shut-off apparatus comprising a first connector sealingly affixable, in use, to a water outlet orifice of a first fire sprinkler head and means for releasably retaining the first connector to the said water outlet orifice, wherein the apparatus further comprises a conduit extending between, and in fluid communication with, the first connector and a second connector, the second connector being adapted to provide a connection, in use, to a second fire sprinkler head affixed thereto.

2. A sprinkler shut-off apparatus as claimed in claim 1, further comprising a second fire sprinkler head detachably affixed to the second connector.

3. A sprinkler shut-off apparatus as claimed in claim 2, wherein the second fire sprinkler head is identical with, or of the same specification as, the first fire sprinkler head.

4. A sprinkler shut-off apparatus as claimed in claim 1, wherein the second connector comprises a screw-fitting type connector.

5. A sprinkler shut-off apparatus as claimed in claim 1, wherein second connector comprises a quick release and/or a push-fit type of connector.

6. A sprinkler shut-off apparatus as claimed in claim 1, wherein the first connector comprises a seal that is adapted to form a seal with the water outlet orifice.

7. A sprinkler shut-off apparatus as claimed in claim 6, wherein the seal comprises a resiliently deformable member.

8. A sprinkler shut-off apparatus as claimed in claim 1, wherein the first connector comprises a centraliser adapted to centralise an inlet orifice of the first connector with an outlet orifice the first sprinkler head.

9. A sprinkler shut-off apparatus as claimed in claim 8, wherein the centraliser comprises a tapered bung having a through aperture adapted to seat inside the first sprinkler head's outlet orifice.

10. A sprinkler shut-off apparatus as claimed in claim 1, wherein the first connector comprises a resiliently deformable tube adapted to seal around the external periphery of the first sprinkler head's water outlet orifice.

11. A sprinkler shut-off apparatus as claimed in claim 1, wherein the means for releasably retaining the first connector to the water outlet orifice comprises a mechanism adapted to engage the first connector with the water outlet orifice.

12. A sprinkler shut-off apparatus as claimed in claim 11, wherein the mechanism comprises an abutment adapted to engage with a part of the first sprinkler head other than its outlet orifice, the abutment being moveable relative to the first connector.

13. A sprinkler shut-off apparatus as claimed in claim 12, further comprising means for biasing the first connector into engagement with the water outlet orifice, the biasing means cooperating with the relatively moveable first connector and abutment for biasing the first connector to engage the first sprinkler's water outlet orifice.

14. A sprinkler shut-off apparatus as claimed in claim 12, further comprising ratchet means for maintaining the first connector in engagement with the water outlet orifice, the ratchet means cooperating with the relatively moveable first connector and abutment for biasing the first connector to engage the first sprinkler's water outlet orifice.

15. A sprinkler shut-off apparatus as claimed in claim 12, wherein the abutment is adapted to engage a retaining flange or a deflector plate of the first sprinkler head.

16. A sprinkler shut-off apparatus as claimed in claim 12, wherein the abutment comprises a forked portion.

17. A sprinkler shut-off apparatus as claimed in claim 16, wherein the forked portion is elongate to allow it to be offered up to first sprinkler head with the first connector clear of the water outlet orifice.

18. A sprinkler shut-off apparatus as claimed in claim 11, wherein the means for releasably retaining is separable from the first connector.

19. A sprinkler shut-off apparatus as claimed in claim 11, wherein the means for retaining comprises two or more spring-loaded arms operatively connected to the first connector, which arms extend towards, and which are adapted to engage a portion of, the first sprinkler head.

20. A sprinkler shut-off apparatus as claimed in claim 11, wherein the means for releasably retaining comprises a hand-operated ratchet mechanism.

21. A sprinkler shut-off apparatus as claimed in claim 1, wherein the conduit comprises a first portion leading to the second connector, and a second portion leading to a bypass outlet.

22. A sprinkler shut-off apparatus as claimed in claim 21, further comprising a diverter valve means adapted to selectively divert a flow of water to one or both of the second connector and the bypass outlet.

23. A sprinkler shut-off apparatus as claimed in claim 22, wherein the diverter valve means comprises an actuator located so as to permit it to be operated single-handedly.

24. A sprinkler shut-off apparatus as claimed in claim 1, wherein the first connector comprises a tube portion extending therefrom, the free end of the tube portion comprising a centraliser for guiding a tip of the tube portion into alignment with the outlet orifice of the first sprinkler head.

25. (canceled)
